(19) United States
(12) Patent Application Publication
(10) Pub. No.: US 2002/0138434 A1
(43) Pub. Date: Sep. 26, 2002

(54) Method and apparatus in a data processing system for a keystore

(75) Inventors: Lok Yan Leung, Austin, TX (US); Anthony Joesph Nadalin, Austin, TX (US); Bruce Arland Rich, Round Rock, TX (US); Theodore Jack London Shrader, Austin, TX (US)

Correspondence Address: Duke W. Yee, Carstens, Yee & Cahoon, LLP, P. O. Box 802334, Dallas, TX, 75380, US

(73) Assignee: IBM Corporation

(21) Appl. No.: 09/751,576

(22) Filed: Dec. 29, 2000

(51) Int. Cl. G06F 17/60

(52) U.S. Cl. 705/51

(57) ABSTRACT

A method, apparatus, and computer implemented instructions for managing access to data in a keystore in a data processing system. A request for access to an item of data is received from a requestor, wherein the item of data is encrypted using a key. A determination of whether the requestor is a trusted requestor is made. The key and the item of data are sent to the requestor in response to a determination that the requestor is a trusted requestor.

### BACKGROUND OF THE INVENTION

1. Technical Field

The present invention provides an improved data processing system and in particular, a method and apparatus for managing data. Still more particularly, the present invention provides a method and apparatus, for managing keys in a Keystore.

2. Description of Related Art

Java is an object oriented programming language and environment focusing on defining data as objects and the methods that may be applied to those objects. Java supports only a single inheritance, meaning that each class can inherit from only one other class at any given time. Java also allows for the creation of totally abstract classes known as interfaces, which allow the defining of methods that may be shared with several classes without regard for how other classes are handling the methods. Java provides a mechanism to distribute software and extends the capabilities of a Web browser because programmers can write an applet once and the applet can be run on any Java enabled machine on the Web.

In addition, Java offers storage for public and private keys, and their associated certificates or certificate chains in a database known as a Keystore. The default Keystore implementation in Java is a flat file in a proprietary form known as a Java Keystore, or JKS. The integrity of the entire database is guaranteed by a cryptographic hash of its contents with a key derived from a password. Each private key in the database may also be protected with a separate password.

In different Keystore implementations that make use of encryption, private keys can be stored encrypted using one of the supported encryption algorithms. The default Keystore that ships with the Java virtual machine (JVM) has a password of “changeit”, and contains certificates for trusted Certificate Authorities (CAs), but no private information as such. A certificate is a file that identifies a person or organization. Certificates may be used to encrypt information and to check the identity of the certificate's owner. Certificates allow a user to receive encrypted information. Most users of Java really do not know about the Keystore, or the fact that the Keystore has a default password that would allow a knowledgeable attacker to update the Keystore with bogus certificates to permit an attack. Furthermore, system code in trusted codebases may want to make use of Keystore information, but would be vulnerable to the user actually changing the password on the Keystore, and the system code no longer knowing how to get at the private information contained within.

Therefore, it would be advantageous to have an improved method and apparatus for a more secure yet accessible Keystore system.

### SUMMARY OF THE INVENTION

The present invention provides a method, apparatus, and computer implemented instructions for managing access to data in a Keystore in a data processing system. A request for access to an item of data is received from a requestor, wherein the item of data is encrypted using a key. A determination of whether the requestor is a trusted requestor is made. The key and the item of data are sent to the requestor in response to a determination that the requestor is a trusted requestor.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram of a Keystore system used in a Java virtual machine in accordance with a preferred embodiment of the present invention;

FIG. 4 is a flowchart of a process used for accessing a key in accordance with a preferred embodiment of the present invention;

FIG. 5 is a flowchart of a process used for adding a key entry to a Keystore object in accordance with a preferred embodiment of the present invention; and

FIG. 6 is a flowchart of a process used for processing a request for a key from a Keystore object in accordance with a preferred embodiment of the present invention.

### DETAILED DESCRIPTION OF THE PREFERRED EMBODIMENT

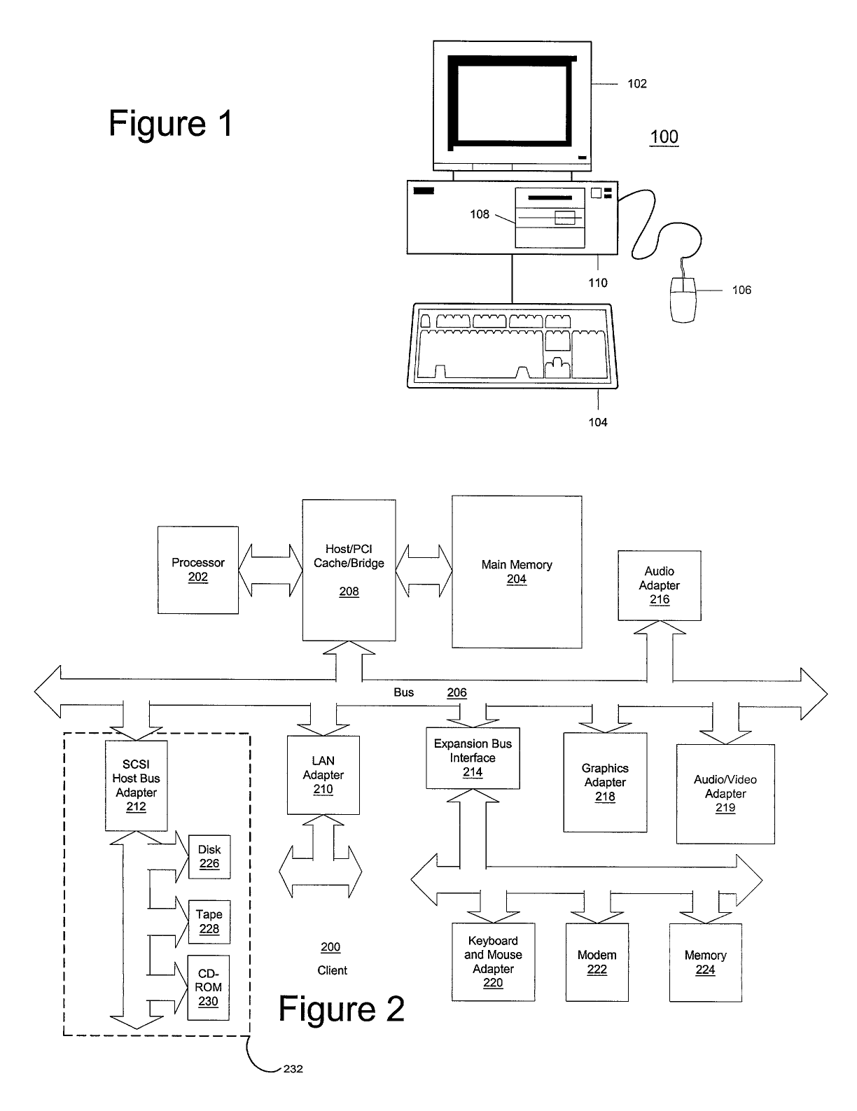

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used.

Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

Thus, the present invention provides an improved method, apparatus, and computer implementable instructions for a secure and accessible Keystore. In particular, the mechanism of the present invention adds another logical section to the Keystore, such as a Java Keystore. This section duplicates the data in a portion of that Keystore, but protects the data with a different password. Entries from this new section are available to any class from a trusted codebase. A “codebase” is expressed as a Uniform Resource Locator (URL), for example “http://w3.ibm.com/classes” or “file:d:/Program Files/test”. The exact meaning of a codebase depends on the characters at its end. A codebase that ends in a trailing slash (“/”) matches all class files (not JAR files) in the specified directory. A codebase that ends in a “/*”) matches all files (both classes and JAR files) contained in the specified directory. A codebase that ends in “/−” matches all files (both classes and JAR files) in the specified directory and recursively all files in all subdirectories contained in the specified directory. A codebase that ends in neither “/*” nor “/−” is treated as ending in “/”. Entries from this new section of the Keystore are made available through a new permission, which signals which codebases should be trusted. This mechanism allows trusted applications to access cryptographically-sensitive information without requiring user input for a password. Further, presuming that the password is a well-known value is not required. The risk of a user changing the password and denying trusted applications of needed information also is avoided.

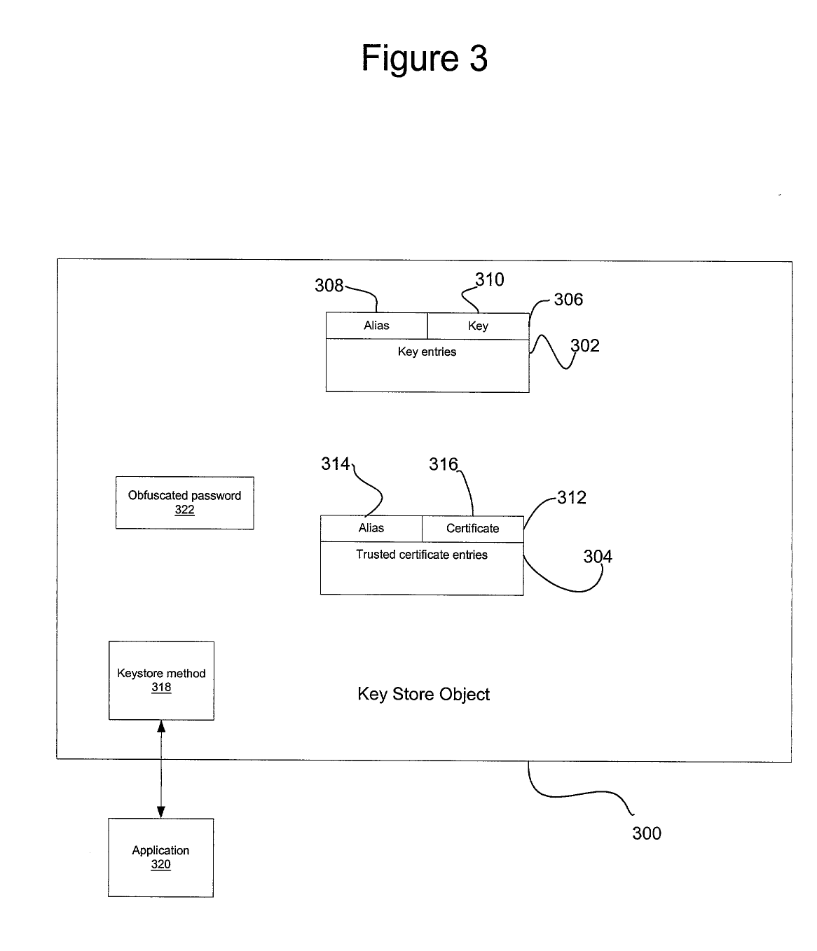

Turning next to FIG. 3, a diagram of a Keystore system used in a Java virtual machine is depicted in accordance with a preferred embodiment of the present invention. In this example, Keystore object 300 includes key entries 302 and trusted certificate entries 304. A “key” Keystore entry holds very sensitive cryptographic key information, which is stored in a protected format to prevent unauthorized access. Typically, a key stored in a “key” Keystore entry is either a secret key (used in symmetric-key cryptography), or a private key (used in asymmetric-key cryptography) accompanied by the certificate chain for the corresponding public key.

A “trusted certificate entry” contains a single public-key certificate that the Keystore owner trusts to sign other certificates, thus anchoring the chain of trust that makes public-key cryptography work. The only way to search through a Keystore is by an “alias” associated with each entry, whether they be a “key” Keystore entry or a “trusted certificate” Keystore entry. For example, entry 306 in key entries 302 includes alias 308 and key 310. Entry 312 in trusted certificate entries 304 includes alias 314 and certificate 316. The access to these entries is handles by Keystore method 318, which handles requests from callers, such as application 320. In these examples, a set of entries within key entries 302 may be encrypted using obfuscated password 322. Theses entries are accessible only if application 320 has permission to access the entries. This determination may be made by various security checks well known in the art. If an entry is accessible, then obfuscated password 322 is used to decrypt the key in these examples. The decrypted key in then returned to the application.

Keystore object 300 will return an Enumeration that allows the caller to iterate through all the entries in the Keystore. Because Keystore object 300 is organized in this fashion, this invention introduces its entries into Keystore object 300 by encoding information into new aliases. This mechanism permits current applications to continue to operate as before, as no new methods need to be called. Depending on the implementation, new methods may be added.

The mechanism of the present invention will get control when a user or application wishes to create a new Keystore entry. In particular, since the “trusted certificate entries” are public information, the present invention need only get control when a new “key” Keystore entry is created. One feature of the present invention is to create not only the entry that the user or application desired, but an additional entry for use by trusted applications.

The new aliases that are introduced in the depicted examples are of the form aaa####ccc. The “####” are delimiters, so that two parts to each new alias can be identified. The part labeled “aaa” is the alias that the user knows about. The part labeled “ccc” is a hidden extension to avoiding overlaying the entry protected with the application's password. In this example, “XKeystore” as our value for “ccc”.

The new aliases are never actually surfaced or presented to using applications. The way that they can be used is by an application calling a method that normally takes an alias and a password, but the application simply passes a null for the password. In this case, the extended Keystore will look for a hidden alias that starts with the alias that was passed in, but ends in the appropriate extension. Finding such an alias, processing continues below with a security check to ascertain the propriety of allowing processing to use the hidden alias to retrieve the data.

To secure usage of these extensions to the Keystore, the mechanism of the present invention provides for a new Permission class. As one of ordinary skill in the art knows, Permission classes extend java.security.Permission, and take either one or two Strings on their constructor. The new Permission class will take two Strings on its constructor. The first String relates to the alias name, and the second String relates to the type of access desired. For purposes of illustration, this new Permission class is called com.ibm.security.XKSPermission. Thus, granting a bill-payment application access to all extended Keystore entries in the normal java.policy file would look like this:

grant codeBase “file:d:/quicken/billpayer.jar” {

permission com.ibm.security.XKSPermission

“*”,“read”;
};

A more restrictive Permission that only lets the bill-payment application access information for a local user named “bob”, would be as follows:

grant codeBase “file:d:/quicken/billpayer.jar” {

permission com.ibm.security.XKSPermission

“*,user.name=bob”,“read”;
};

A Permission that takes into account the user's JAAS identity and only allows access for someone named “kermit” who had authenticated through Kerberos would be as follows:

grant codeBase “file:d:/quicken/billpayer.jar”,

principal com.ibm.security.KerberosPrincipal

“kermit” {

permission com.ibm.security.XKSPermission

“*”,“read”;
};

For purposes of illustration, the extended Keystore class is called com.ibm.security.XKeyStore. When XKeyStore is requested to return information on an alias that would make use of a hidden alias (getKey(alias, null)) XKeyStore will check permissions on the hidden aliaseses in a code sequence similar to:

SecurityManager sm = System.getSecurityManager( );
if (sm != null) { // a security manager has been set

sm.checkPermission( new

com.ibm.security.XKSPermission( alias, “read”);
}

And if the Permission was not granted, a SecurityException will be thrown, caught by XKeyStore (which now knows that the application has not been authorized to use the extended entries) and a null will be returned on the getKey() call.

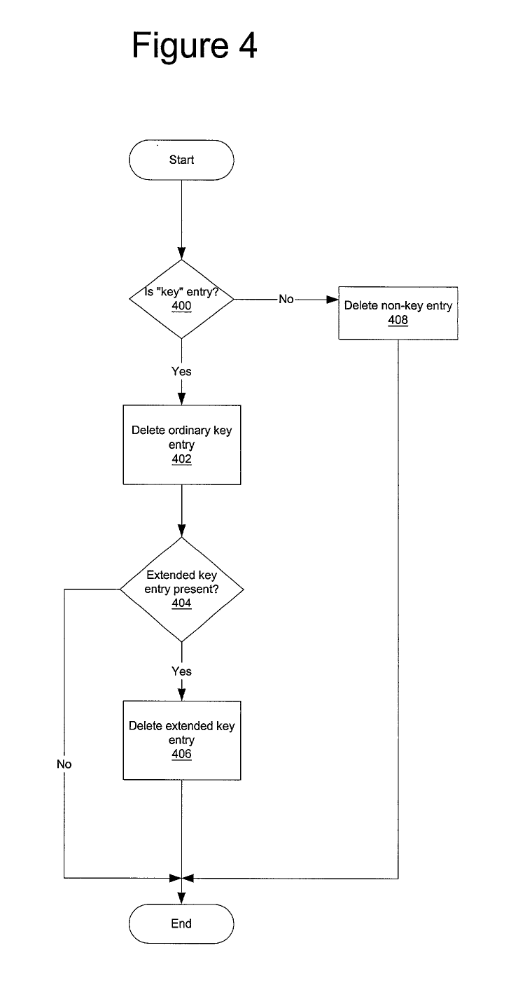

With reference next to FIG. 4, a flowchart of a process used for accessing a key is depicted in accordance with a preferred embodiment of the present invention. The process illustrated in FIG. 4 may be implemented within the Keystore system, such as Keystore object 300 illustrated in FIG. 3. This process is initiated in response to an application requesting deletion of any entry.

The process begins by determining whether the entry is a key entry (step 400). If the entry is a key entry, the ordinary key entry is deleted (step 402). Next, a determination is made as to whether an extended key entry exists (step 404). If an extended key entry exists, this extended key entry is deleted (step 406) with the process terminating thereafter. Otherwise, the process terminates without further action.

With reference again to step 400, if the entry is not a key entry, the non-key entry is deleted (step 408) with the process terminating thereafter.

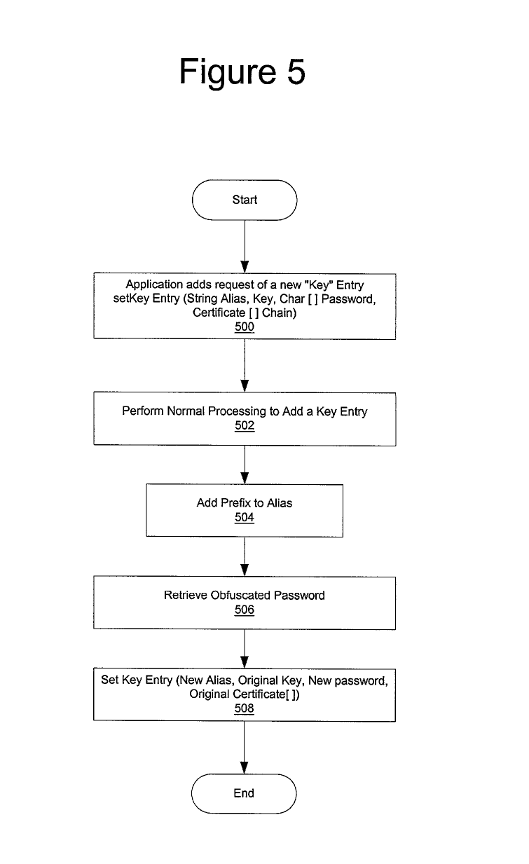

Turning next to FIG. 5, a flowchart of a process used for adding a key entry to a Keystore object is depicted in accordance with a preferred embodiment of the present invention. The process illustrated in FIG. 5 may be implemented within the Keystore system, such as Keystore object 300 illustrated in FIG. 3. This process is initiated in response to an application requesting addition of a new key entry.

The process begins with the application adding a request of a new key entry as follows: setKey Entry (String Alias, Key, Char [] Password, Certificate [] Chain) (step 500). This request includes a requested alias, an identification of the key, password, and certificate chain. Next, normal processing to add a key entry is performed (step 502).

Then, a prefix to the alias is added (step 504). The obfuscated password is retrieved (step 506) from its hidden location inside the XKeyStore class. Next, the key entry is set (New Alias, Original Key, New password, Original Certificate[]) (step 508) with the process terminating thereafter. The new alias, in this example, is the original alias with a prefix. The password in this step is the obfuscated password retrieved in step 506.

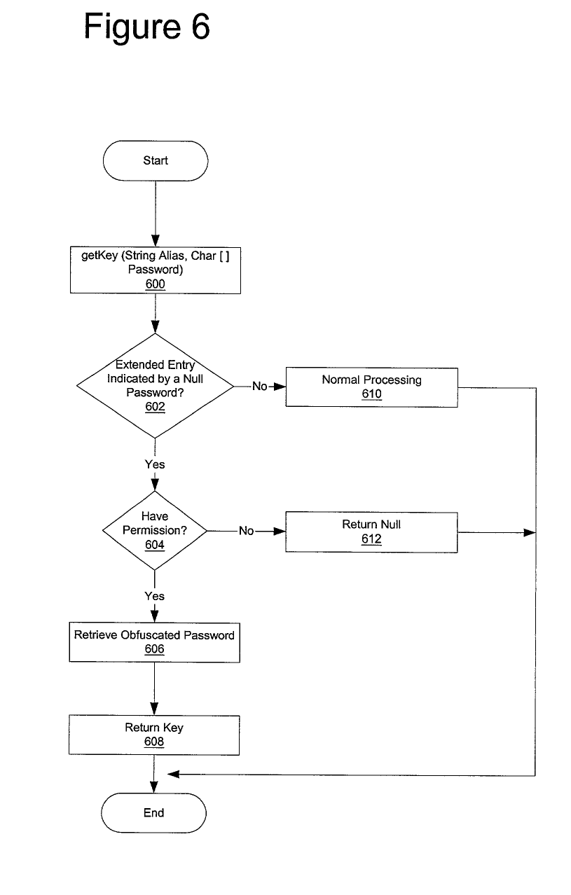

Turning next to FIG. 6, a flowchart of a process used for processing a request for a key from a Keystore object is depicted in accordance with a preferred embodiment of the present invention. The process illustrated in FIG. 6 may be implemented within the Keystore system, such as Keystore object 300 illustrated in FIG. 3. This process is initiated in response to an application requesting access to a key.

The process begins with getKey (String Alias, Char [] Password) (step 600). This request is received from an application. Next, a determination is made as to whether the entry is an extended entry, which means that no password is supplied on the call (step 602). In other words, a null password is supplied. If the entry is an extended entry, a determination is made as to whether the application has permission to access the key (step 604). If the application does have permission, the obfuscated password is retrieved (step 606), so that the key can be decrypted and returned to the application. Both private and secret keys are obscured in some way when they are stored in a Keystore object. In other words, these keys are not accessible directly by requests from requestors outside of the Keystore object. In these examples, the password is necessary to retrieve the key from its obscured state. Depending on the implementation detail, it may be preferable from a performance point of view to decrypt all the keys belonging to extended aliases when the Keystore object is first created, but the decryption need not be done until this point otherwise.

Then, the key is returned to the application (step 608) with the process terminating thereafter. With reference again to step 602, if the entry is not extended, normal processing is performed (step 610) with the process terminating thereafter. With reference again to step 604, if one does not have permission, a null is returned (step 612) with the process terminating thereafter.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing access to data in a keystore, the method comprising:
receiving a request for access to an item of data from a requestor, wherein the item of data is encrypted using a key;
determining whether the requestor is a trusted requestor;
responsive to a determination that the requestor is a trusted requestor, decrypting the item of data using the key to form a decrypted item of data; and
sending the decrypted item of data to the requestor.

2. The method of claim 1, wherein the requestor is an application.

3. The method of claim 1, wherein the Keystore is a Java Keystore.

4. The method of claim 1, wherein the item of data is another key.

5. The method of claim 1, wherein the item of data is a certificate.

6. The method of claim 1, wherein the item of data is indexed within the Keystore using an alias.

7. The method claim 6, wherein the request includes the alias further comprising:
responsive to an absence of a determination that the requestor is a trusted requestor, returning a null result to the requestor.

8. The method of claim 1 further comprising:
responsive to receiving a request to add a new item of data to the Keystore, encrypting the new item of data to form an encrypted item of data; and
storing the encrypted item of data in the Keystore.

9. The method of claim 8 further comprising:
storing the new item of data in the Keystore.

10. The method of claim 8, wherein each item of data in the Keystore is associated with an alias.

11. A method in a data processing system for managing access to data in a keystore, the method comprising:
receiving a request for access to an item of data from a requestor, wherein the item of data is encrypted using a key;
determining whether the requestor is a trusted requestor; and
responsive to a determination that the requestor is a trusted requestor, sending the key and the item of data to the requestor.

12. A Keystore system comprising:
a Keystore object including:
a key; and
a plurality of entries, wherein each entry within the plurality of entries is encrypted using the key; and
a Keystore process, wherein the Keystore process provides access to the plurality of entries in response to a request from a trusted application by providing the key to the trusted application.

13. The Keystore system of claim 12, wherein the plurality of entries is indexed using a plurality of aliases and wherein the request includes an alias for a requested entry.

14. The Keystore system of claim 12, wherein the plurality of entries is a first plurality of entries and wherein the Keystore object includes a second plurality of entries corresponding to the first plurality of entries in an unencrypted form.

15. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to receive a request for access to an item of data from a requestor, wherein the item of data is encrypted using a key, determine whether the requestor is a trusted requestor, and send the key and the item of data to the requestor, in response to a determination that the requestor is a trusted requestor.

16. The data processing system of claim 15, wherein the bus system includes a primary bus and a secondary bus.

17. The data processing system of claim 15, wherein the processor unit includes a single processor.

18. The data processing system of claim 15, wherein the processor unit includes a plurality of processors.

19. The data processing system claim 15, wherein the communications unit is an Ethernet adapter.

20. A data processing system for managing access to data in a datastore, the data processing system comprising:
receiving means for receiving a request for access to an item of data from a requestor, wherein the item of data is encrypted using a key;
determining means for determining whether the requestor is a trusted requestor; and
decrypting means, responsive to a determination that the requestor is a trusted requestor, for decrypting the item of data using the key to form a decrypted item of data; and
sending means for sending the decrypted item of data to the requestor.

21. The data processing system of claim 20, wherein the requestor is an application.

22. The data processing system of claim 20, wherein the Keystore is a Java Keystore.

23. The data processing system of claim 20, wherein the item of data is another key.

24. The data processing system of claim 20, wherein the item of data is a certificate.

25. The data processing system of claim 20, wherein the item of data is indexed within the Keystore using an alias.

26. The data processing system claim 25, wherein the request includes the alias further comprising:
returning means, responsive to an absence of a determination that the requestor is a trusted requestor, for returning a null result to the requestor.

27. The data processing system of claim 20 further comprising:
encrypting means, responsive to receiving a request to add a new item of data to the Keystore, for encrypting the new item of data to form an encrypted item of data; and
storing means for storing the encrypted item of data in the Keystore.

28. The data processing system of claim 27, wherein the storing means is a first storing means further comprising:
second storing means for storing the new item of data in the Keystore.

29. The data processing system of claim 27, wherein each item of data in the Keystore is associated with an alias.

30. A data processing system for managing access to data in a datastore, the data processing system comprising:
receiving means for receiving a request for access to an item of data from a requestor, wherein the item of data is encrypted using a key;
determining means for determining whether the requestor is a trusted requestor; and
sending means, responsive to a determination that the requestor is a trusted requestor, for sending the key and the item of data to the requestor.

31. A computer program product in a computer readable medium for managing access to data in a datastore, the computer program product comprising:
first instructions for receiving a request for access to an item of data from a requestor, wherein the item of data is encrypted using a key;
second instructions for determining whether the requestor is a trusted requestor; and
third instructions, responsive to a determination that the requestor is a trusted requestor, for sending the key and the item of data to the requestor.

32. A computer program product in a computer readable medium for managing access to data in a datastore, the computer program product comprising:
first instructions for receiving a request for access to an item of data from a requestor, wherein the item of data is encrypted using a key;
second instructions for determining whether the requestor is a trusted requestor;
third instruction, responsive to a determination that the requestor is a trusted requestor, for decrypting the item of data using the key to form a decrypted item of data; and
fourth instructions for sending the decrypted item of data to the requestor.
